(19) United States
(12) Patent Application Publication
(10) Pub. No.: US 2025/0069484 A1
(43) Pub. Date: Feb. 27, 2025

(54) GAME HAVING A PREVIEW VIEW

(71) Applicant: John FOX, Omaha, NE (US)

(72) Inventor: John FOX, Omaha, NE (US)

(21) Appl. No.: 18/942,129

(22) Filed: Nov. 8, 2024

Related U.S. Application Data
(63) Continuation of application No. 16/205,963, filed on Nov. 30, 2018, now abandoned.
Application No. 16/205,963 is a continuation-in-part of application No. 14/223,446, filed on Mar. 24, 2014, now abandoned.

(51) Int. Cl. G07F 17/32; G07F 17/42

(52) U.S. Cl. CPC G07F 17/3295; G07F 17/323; G07F 17/3246; G07F 17/3262; G07F 17/42

(57) ABSTRACT

A method of conducting a game of skill includes providing a game device having a display for use by a player; inputting a quantity of points into the game device in a player account by the player inserting a physical item into an acceptor wherein the physical item has cash value; selecting a quantity of points per play by the player by using at least one player input button; and displaying on the display a game view and a preview view for viewing by the player. The method continues with initiating a proposed game play by the player by the player activating a game play button; generating a set of symbols for the proposed game play for display on the preview view for potential play by the player for viewing by the player wherein the proposed game play has an outcome that is based on selected ones of a plurality of basic-game symbols, wherein potential points to be awarded for the proposed game play are based on a pay table; evaluating, by the player, the proposed game play; and accepting the proposed game play, by the player via an input button, wherein the selected points per play are deducted from the player account, wherein the set of symbols for the proposed game play is displayed on the game view, wherein the player account is credited with the potential points based on the pay table, or, declining the proposed game play by the player, or activation of the game play button in order to preview another. The method repeats the steps starting with the step of initiating a proposed game play. Finally, the method is terminated by the player activating a redeem button, wherein a ticket is printed by the electronic game device and output through a ticket printer (e.g. for coded card, bankcard, token, or even currency).

### CROSS-REFERENCE TO RELATED APPLICATIONS

This application is a continuation application of U.S. patent application Ser. No. 16/205,963 entitled Game Having a Preview View, filed Nov. 30, 2018, which is a continuation-in-part application of U.S. patent application Ser. No. 14/223,446, entitled Electronic Game Having A Preview View, filed Mar. 24, 2014, pending.

### BACKGROUND OF THE INVENTION

The present invention is directed to games of skill. More particularly, the present invention is directed to skill-based games where the outcome of play is substantially, predominantly or entirely determined by the skill of the player and not by random chance or predetermined odds.

A game of skill is a game, sometimes played on a machine whereby a result is derived substantially, predominantly or entirely by the player or participant's use of skills, as opposed to the result being controlled entirely by chance. In other words, it is a game where the players or participants rely on their skill to get to the final result and not upon chance. There are sometimes debates as to what constitutes a game of skill. A game of skill is a game where the outcome is determined mainly by mental and/or physical skill, rather than by pure chance.

It is generally agreed that skill games contain one or more, and in some cases all of the following:
1. a strategy to be applied;
2. the ability for the participant to improve;
3. an undefined or incalculable win rate; and
4. the player's skill or actions are the controlling factor in the game, rather than chance (this being the most widely accepted feature of a skill game).

Typically, the outcome of a play of the game must be controlled by the player playing the game and not by predetermined odds or random chance. Some chance may be part of the game, but skill must be the main feature.

Games of skill include many different types of games and come in many different forms and packages. They can be found in a wide variety of places and locations. Common examples of skill games include pool, darts, golf, trivia, and target shooting games. Such games can be found in taverns, arcades, grocery and retail stores, carnivals, festivals, and golf courses. Skill games often reward prizes and return something of value to the participants. These rewards are typically toys, stuffed animals, gift certificates, tokens, coins and currency, and an endless array of novelties and merchandise.

Games of skill can also be found in many different places in many different locations. There are also many activities where people are able to win prizes for participating in games and other events. A few examples of places where games of skill can be found and other games where prizes can be won include arcades, retail stores, carnivals and festivals, state and county fairs, specialty restaurants, theme parks, special promotions, tournaments and leagues, game shows, and sports and performance-based pay.

Coin operated games of skill can be found all around us. Arcades, hotels, retail stores, and restaurants all play host to such games of skill. Coin operated, and sometimes non-coin operated games of skill can be found among other places at carnivals, state fairs, and church or school festivals.

There are a vast array of means and methods to compete for and obtain prizes that have little or nothing to do with chance. A golf tournament, playing a Cyclone game, or selling cookies are just a few clear examples whereby prizes can be won.

Games of skill can take the form of electronic video games, more commonly seen in “gaming” type games. Additionally, on such electronic video screens, preview screens or views are known. Here, a preview of a field of game symbols is displayed before actual play. For example, U.S. Pat. No. 7,736,223 (Pace) is directed to an electronic gaming method with a preview display. A field of game symbols is presented on the display to the player as a preview for deciding whether or not to play the next game. In this particular variation, if the player decides to play the game, the player selects a field element to turn the symbol displayed into a wild symbol. The winning combinations of symbols are then displayed.

All references cited herein are incorporated herein by reference in their entireties.

### BRIEF SUMMARY OF THE INVENTION

A method of conducting a game of skill is provided, including the steps of providing a game device having a display for use by a player; inputting a quantity of points (including tokens, coins or currency, etc.) into the game device in a player account by the player inserting a physical item into an acceptor wherein the physical item has cash value; selecting a quantity of points per play by the player by using at least one player input button; and displaying on the display a game view and a preview view for viewing by the player.

The method continues with the steps of initiating a proposed game play by the player by the player activating a game play button; generating a set of symbols for the proposed game play, for display on the preview view for potential play by the player for viewing by the player, wherein the proposed game play has an outcome that is based on selected ones of a plurality of basic-game symbols, wherein potential points to be awarded for the proposed game play are based on a pay table; evaluating, by the player, the proposed game play; and accepting the proposed game play by the player via an input button, wherein the selected points per play are deducted from the player account, wherein the set of symbols for the proposed game play is displayed on the game view, and wherein the player account is credited with the potential points based on the pay table, or, declining the proposed game play by the player, or again activating the game play button. The steps in this paragraph are repeated as many times as desired by the player.

Finally, the method is terminated by the player activating a redeem button, wherein a ticket is printed by the electronic game device and output through a ticket printer (e.g., coded card, bankcard, token or even currency), and wherein the ticket includes indicia showing points won.

The method may include simultaneously displaying the preview view and the game view. The step of providing a game having a display may include providing a set of mechanical reels. The step of providing a game having a display may include providing an interactive touch screen display. The acceptor may be an acceptor selected from the group consisting of a bank card acceptor, a currency acceptor and a ticket acceptor.

### BRIEF DESCRIPTION OF THE SEVERAL VIEWS OF THE DRAWINGS

The invention will be described in conjunction with the following drawings in which like reference numerals designate like elements throughout the several views and wherein:

FIG. 1 is an isometric view of a game device for use with a method of conducting a game of skill in accordance with an exemplary embodiment of the present invention, wherein the display of the game device shows a mechanical reel style game view and a preview view;

FIG. 2 is a simplified detail view of the game device of FIG. 1;

FIG. 3 is an isometric view of the game device of FIG. 1, wherein the display of the game device shows an electronic touch screen game view and a preview view;

FIG. 4 is a simplified detail view of the game device of FIG. 3; and

FIG. 5 is a flowchart of the method of conducting a game of skill of FIG. 1.

### DETAILED DESCRIPTION OF THE INVENTION

The invention will be illustrated in more detail with reference to the following embodiment, but it should be understood that the present invention is not deemed to be limited thereto.

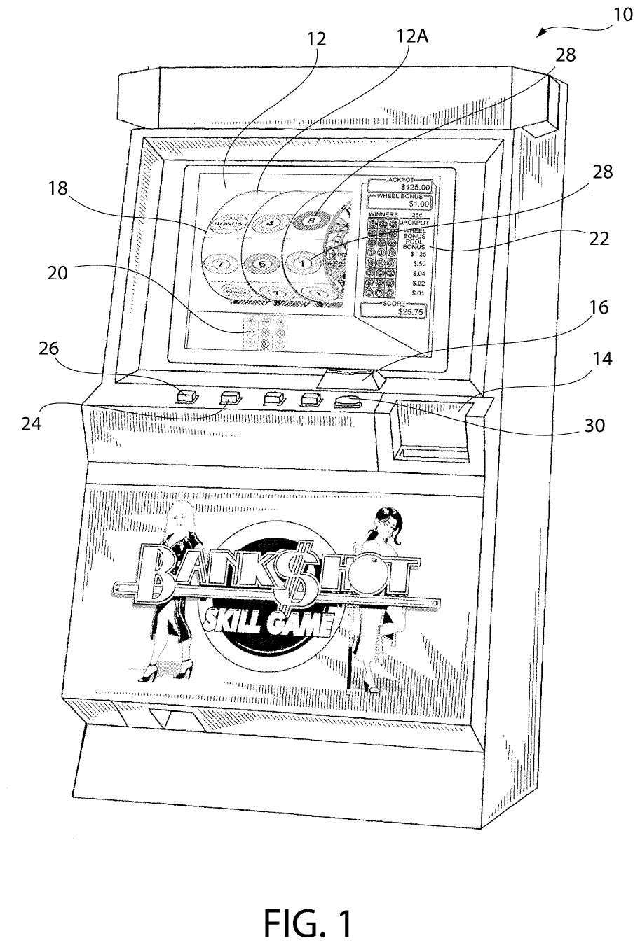

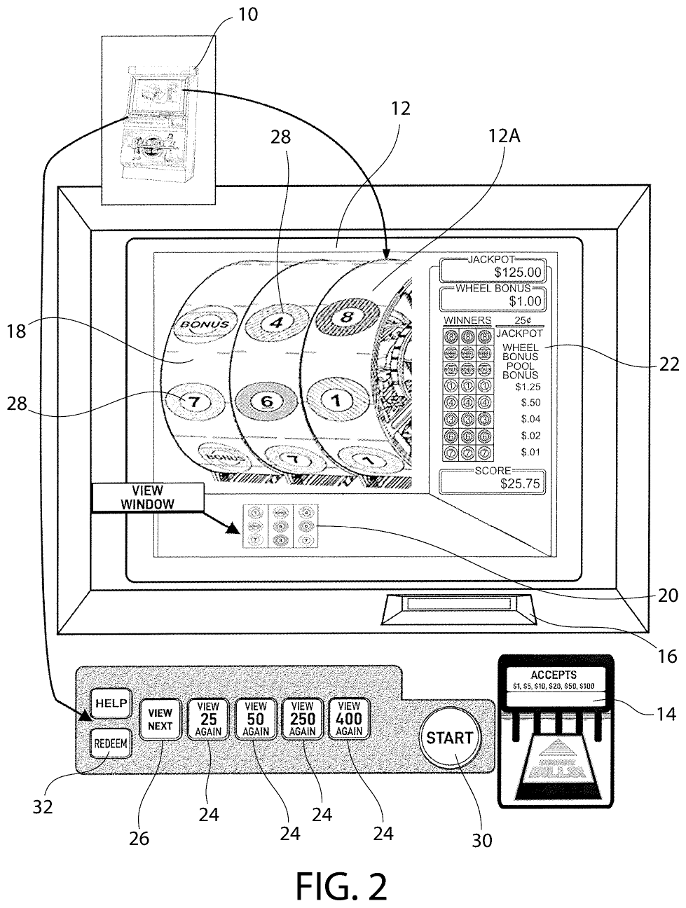

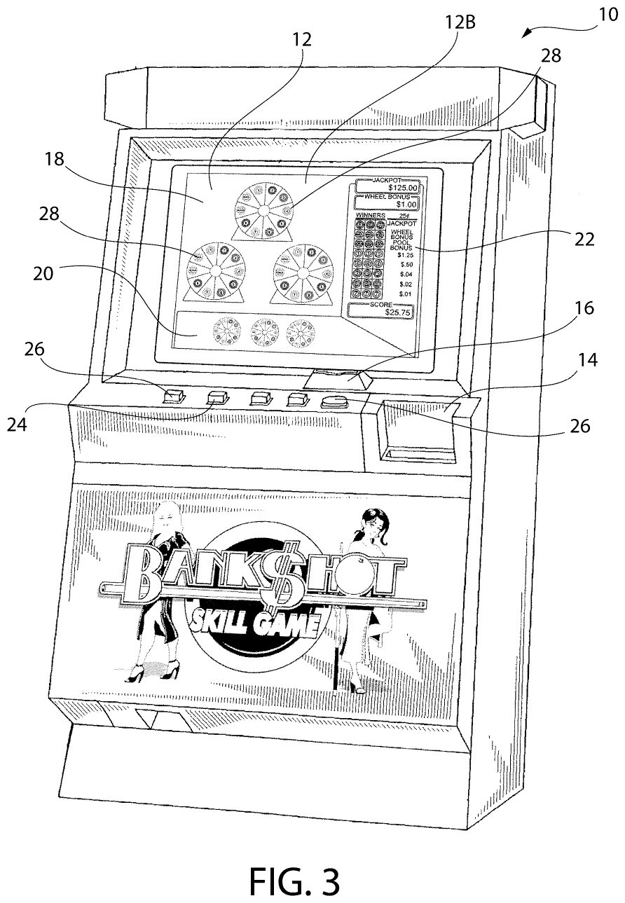

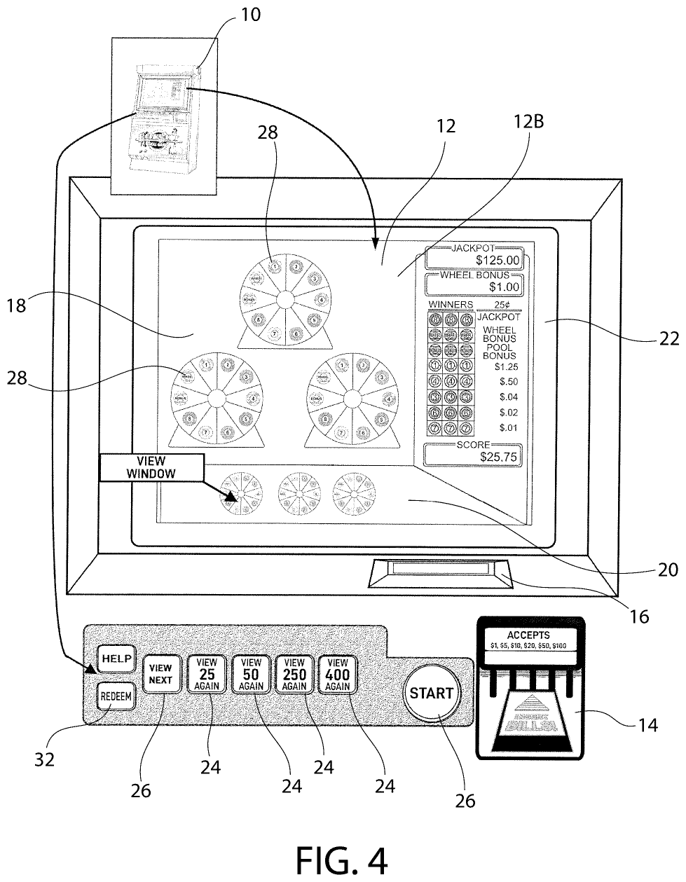

Referring now to the drawing figures, wherein like reference numbers refer to like elements throughout the several views, there is shown in FIGS. 1-4 a game device 10 for use with the method of conducting a game of skill in accordance with an exemplary embodiment of the present invention. The game device 10 preferably includes a display 12, such as a plurality of mechanical reels 12A (see FIGS. 1-2) or a touch screen display or displays 12B (see FIGS. 3-4), a bankcard/currency/ticket acceptor 14 for inputting points and/or receiving points, and a ticket printer (e.g., coded card, bankcard, token, or even currency) 16 for optionally printing a ticket with awarded points. In the game device 10 of FIGS. 1-4, the display 12 includes two different views, a game view 18 and a preview view 20. The preview view 20 is preferably, but not necessarily, smaller than the game view 18. FIGS. 1-4 shows the display 12 showing a pay table 22, which is described in more detail below.

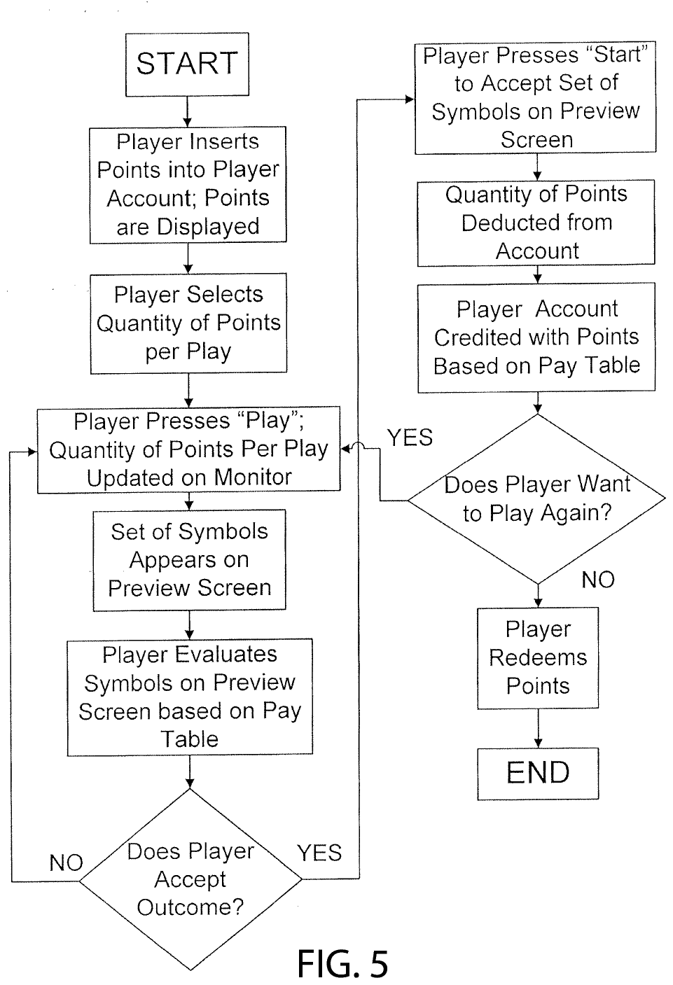

Referring now to the flowchart of FIG. 5, there is shown a method of conducting a game of skill in accordance with an exemplary embodiment of the present invention. The method includes the steps of providing the game device 10 having the display 12 for use by a player. The player physically inputs a quantity of points (via a physical item that has or holds cash value such as currency or a bank card) into the game device 10, via the acceptor 14 into a player account (which may be displayed on the display 12 as player credits 24).

As stated above, a game view 18 and a preview view 20 are displayed on the display 12. The player selects a quantity of points to play using at least one player input button 24. A proposed game play is initiated by the player, by for example, the player pressing a game play button (e.g., “View Next” button 26). As shown in FIGS. 1-4, a set of symbols 28 for the proposed game play is generated by the game device 10, for display on the preview view 20 for potential play by the player for viewing by the player.

The proposed game play has an outcome that is based on selected ones of a plurality of basic-game symbols 28. Potential points to be awarded for the proposed game play are based, for example, on the pay table 22. See FIGS. 1-4.

The player evaluates the proposed game play as shown in the preview view 20. He or she either accepts the proposed game play (for example, by pressing an input button such as “start” button 30), or declines the proposed game play (for example, by re-pressing the “view next” button 26). If the player accepts the proposed game play, the quantity of points per play is deducted from the player account, the set of symbols for the proposed game play is displayed on the game view (i.e., moves from the preview view 20 to the game view 18), and the player account is credited with the potential points based on the pay table 22. The method then repeats, starting with the step of initiating a new proposed game play, by the player. If the player declines the proposed game play, the method also repeats starting with the step of initiating a new proposed game play, but points are not credited. The preview view 20 and the game view 18 are preferably available to view by the viewer simultaneously. Finally, the player may terminate the method by the player activating a redeem button 32, wherein a ticket is printed by the game device and output through the ticket printer 16, wherein the ticket includes indicia showing points won.

The above explanation has included an exemplary embodiment to perform a method of conducting a game of skill including providing a game device having a display for use by a player, initiating a proposed game play by the player; generating a set of symbols for the proposed game play, evaluating by the player the proposed game play, accepting the proposed game play by the player, and then repeating these steps. This embodiment has relied on the use of technology to achieve advantages that are not obtained by the prior art. In particular, by enabling a user to interact with a display using physical buttons to activate, at least in some cases, mechanical reels, the user is able to evaluate and respond. While the advantages of this technology are easily appreciated, a player evaluates anywhere from a single game option to, perhaps dozens or even hundreds. As a result, a computing device may be operated more efficiently than in the prior art.

While the invention has been described in detail and with reference to specific the embodiment thereof, it will be apparent to one skilled in the art that various changes and modifications can be made therein without departing from the spirit and scope thereof.

What is claimed is:

1. A method of conducting a game of skill, comprising:
(a) providing a game device having a display for use by a player;
(b) inputting a quantity of points into the game device in a player account, by the player inserting a physical item into an acceptor, wherein the physical item has cash value;
(c) selecting a quantity of points per single game play by the player by using at least one player input button;
(d) displaying on the display a game view and a preview view for viewing by the player;
wherein, a single game play includes the steps consisting of, in order:
(i) initiating a proposed game play based on the quantity of points per play selected by the player, by the player activating a game play button;
(ii) generating a set of symbols for the proposed game play, for display on the preview view for potential play by the player, for viewing by the player, wherein the proposed game play has an outcome that is based on selected ones of a plurality of basic-game symbols, wherein potential points to be awarded for the proposed game play are based on a pay table;
(iii) accepting the proposed game play, by the player via an input button, wherein the selected points per play are deducted from the player account, wherein the set of symbols for the proposed game play is displayed on the game view, wherein the player account is credited with the potential points based on the pay table, or declining the proposed game play by the player;
(iv) repeating steps (i) through (iii) at least one time; and
(e) terminating the method by the player activating a redeem button, wherein a ticket is printed by the electronic game device and output through a ticket printer, wherein the ticket includes indicia showing points won.

2. The method of conducting a game of skill of claim 1, including simultaneously displaying the preview view and the game view.

3. The method of conducting a game of skill of claim 1, wherein the step of providing a game having a display includes providing a set of mechanical reels.

4. The method of conducting a game of skill of claim 1, wherein the step of providing a game having a display includes providing an interactive touch screen display.

5. The method of conducting a game of skill of claim 1, wherein the acceptor is an acceptor selected from the group consisting of a bank card acceptor, a currency acceptor and a ticket acceptor.
